(19) United States
(12) Patent Application Publication
(10) Pub. No.: US 2013/0093688 A1
(43) Pub. Date: Apr. 18, 2013

(54) Virtual Soft Keys in Graphic User Interface with Side Mounted Touchpad Input Device

(71) Applicants: Matthew Nicholas Papakipos, Palo Alto, CA (US); Matthew Cahill, San Francisco, CA (US)

(72) Inventors: Matthew Nicholas Papakipos, Palo Alto, CA (US); Matthew Cahill, San Francisco, CA (US)

(21) Appl. No.: 13/275,135

(22) Filed: Oct. 17, 2011

(51) Int. Cl. G06F 3/041

(52) U.S. Cl. 345/173

(57) ABSTRACT

In one embodiment, virtual soft keys of a computing devices are implemented with a side-mounted touchpad.

### TECHNICAL FIELD

The present disclosure relates generally to touch-based user interfaces, and more particularly to, implementing virtual soft keys for a computing device having a side-mounted touchpad.

### BACKGROUND

A touchpad is an input device including a surface that detects touch-based inputs of users. A touch screen is an electronic visual display that detects the presence and location of user touch inputs. Mobile devices such as a mobile phone, a tablet computer, and a laptop computer often incorporate a touch screen or a touchpad to facilitate user interactions with application programs running on the mobile device.

### SUMMARY

Particular embodiments relate to implementing virtual soft keys for a computing device having a touchpad disposed on a lateral edge of the computing device. These and other features, aspects, and advantages of the disclosure are described in more detail below in the detailed description and in conjunction with the following figures.

### BRIEF DESCRIPTION OF THE DRAWINGS

FIG. 1 illustrates an example touch screen of a mobile phone that hosts a browser client displaying a web page.

FIG. 2 illustrates an example processing stack of a mobile device with touch-based input device(s).

FIG. 3 illustrates a front view and a side view of an example mobile device with a front-mounted touch screen and a side-mounted touchpad.

FIG. 3A illustrates another example of the mobile device in FIG. 3.

FIG. 3B illustrates an example mobile device with a back-mounted touch surface.

FIGS. 3C-3D illustrate example touch events associated with the example mobile device of FIG. 3.

FIG. 3E-3F illustrate example touch events associated with the example mobile device of FIG. 3B.

FIG. 4 illustrates an example method of implementing virtual soft keys by using a side-mounted touchpad.

FIG. 5A-5B illustrate examples of displaying one or more icons adjacent to a side-mounted touchpad.

FIG. 5C illustrates an example of determining an icon adjacent to a tap event by the tap event's location as determined by zoning.

FIG. 5D illustrates an example of determining an icon corresponding a tap event associated with the back-mounted touch surface of the mobile device in FIG. 3B.

FIG. 6 illustrates an example mobile device platform.

### DETAILED DESCRIPTION

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

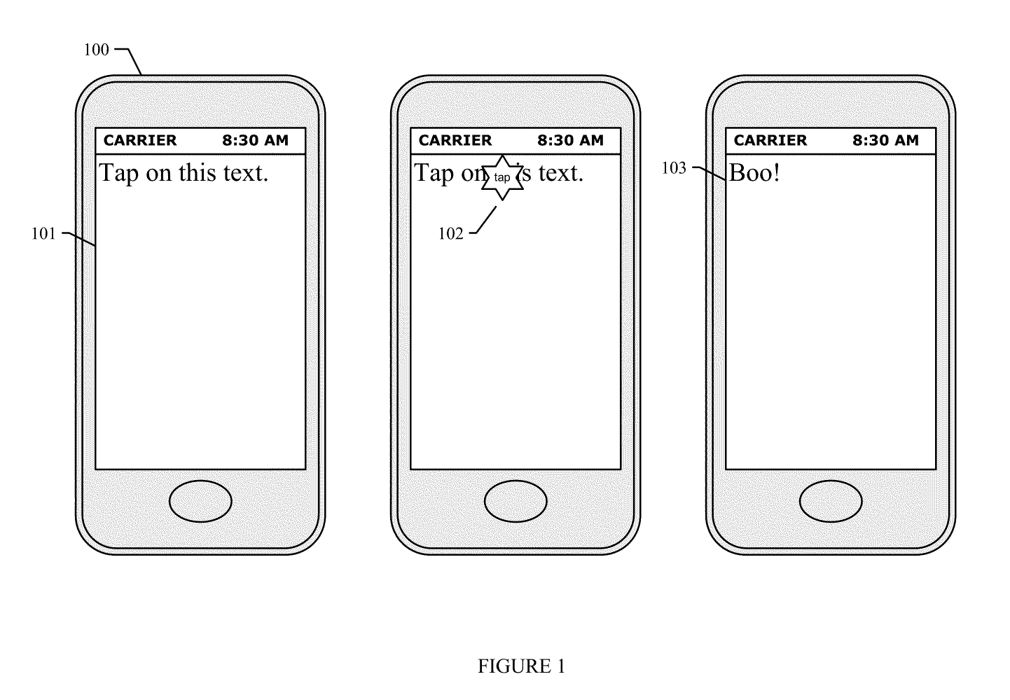

A touchpad is an input device including a surface that detects touch-based inputs of users. Similarly, a touch screen is an electronic visual display that detects the presence and location of user touch inputs. So-called dual touch or multi-touch displays or touchpads refer to devices that can identify the presence, location and movement of more than one touch input, such as two or three finger touches. A system incorporating one or more touch-based input devices may monitor one or more touch-sensitive surfaces for one or more touch or near touch inputs from a user. When one or more such user inputs occur, the system may determine the distinct area(s) of contact and identify the nature of the touch or near touch input(s) via geometric features and geometric arrangements (e.g., location, movement), and determine if they correspond to various touch events (e.g., tap, drag, swipe, pinch). These touch events may then be processed by handler functions that register or subscribe as listeners to such events, as illustrated in FIG. 1. FIG. 1 illustrates an example touch screen of a mobile phone that hosts a browser client displaying a web page. In the example of FIG. 1, touch screen 101 of mobile phone 100 displays an HTML/JavaScript code snippet displaying a text string “Tap on this text”, as listed below.

<html>
<!-- pseudo-code to include a touch event listener from a touch events
library
library TouchEventsLibrary
function onTapEvent
-->
<body>
<h1 onTapEvent=“this.innerHTML=‘Boo!’”>Click on this text</h1>
</body>
</html>

As a user taps on the text string “Tap on this text.” (102), a touch event listener “onTouchEvent” can trigger an action of changing the text string from “Tap on this text.” to “Boo!” (103).

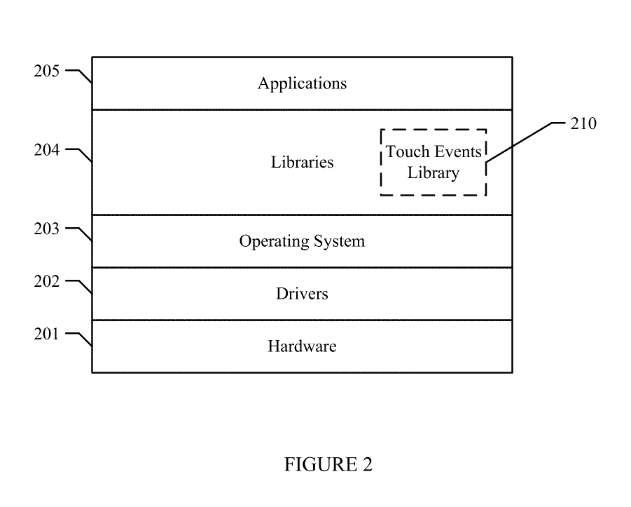

Recognition of touch events by a system with one or more touch-based input devices—i.e., identifying one or more touch inputs by a user and determining corresponding touch event(s)—may be implemented by a combination of hardware, software, and/or firmware (or device drivers). FIG. 2 illustrates an example processing stack of a mobile device (e.g., a smart phone) with touch-based input device(s). Hardware layer 201 can include one or more processors and various hardware input/output devices such as camera, communication interface, and touch-based input device (e.g., touch screen, touchpad). Drivers layer 202 includes one or more drivers that communicate and control hardware layer 200, for example, a driver receiving and processing touch input signals generated by a touch-screen display. Operating system 203 runs computing programs and manages hardware layer 201 via one or more drivers in driver layer 202. Libraries 204 includes one or more libraries used by one or more application programs in applications 205 (e.g., web browser, address book, etc.). For example, touch events library 210 can contain codes that interpret touch inputs to touch events or gestures, and a web browser application program can access touch event library 210 (e.g., via function calls) and process a web page with touch event handlers embedded within the page, as illustrated in FIG. 1 and in the HTML/JavaScript code snippet above.

A soft key is a hardware button that is programmable to invoke one or more functions. For example, each of a computer keyboard's function keys can have different functions for different application programs. For example, a computer keyboard can have LED displays disposed adjacent to function keys. Soft keys are often located adjacent a visual display, as often found on mobile phones, MP3 players and automatic teller machines, and the visual display can display a corresponding icon or function for each of the soft keys.

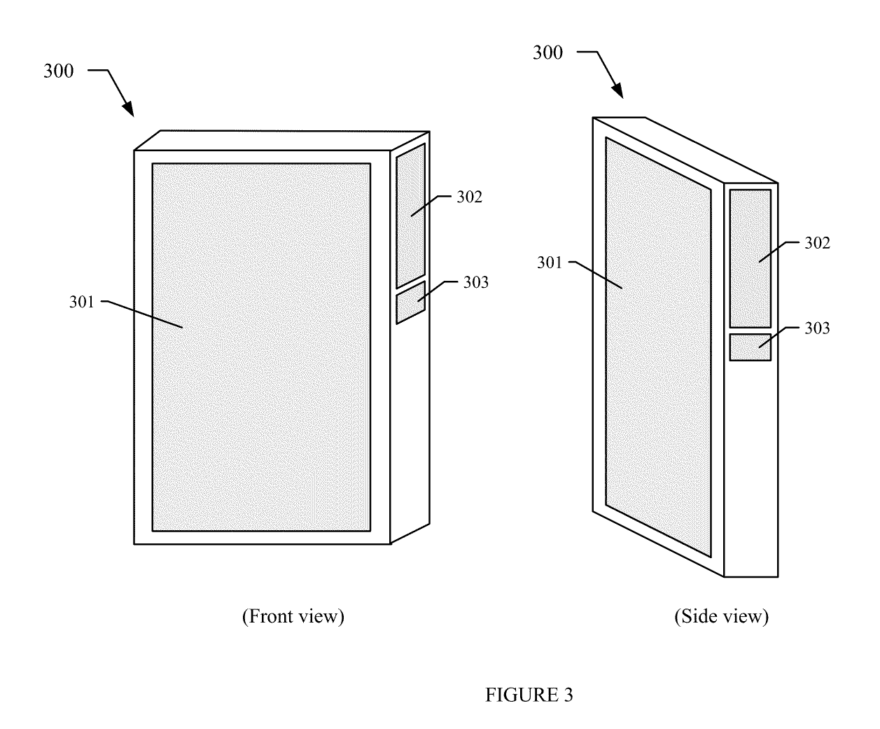

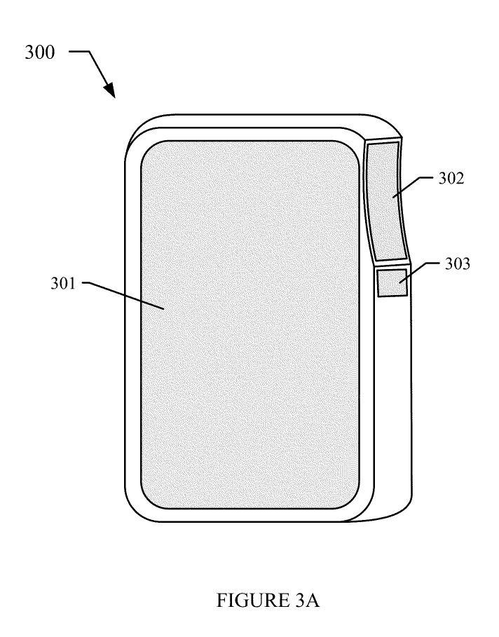

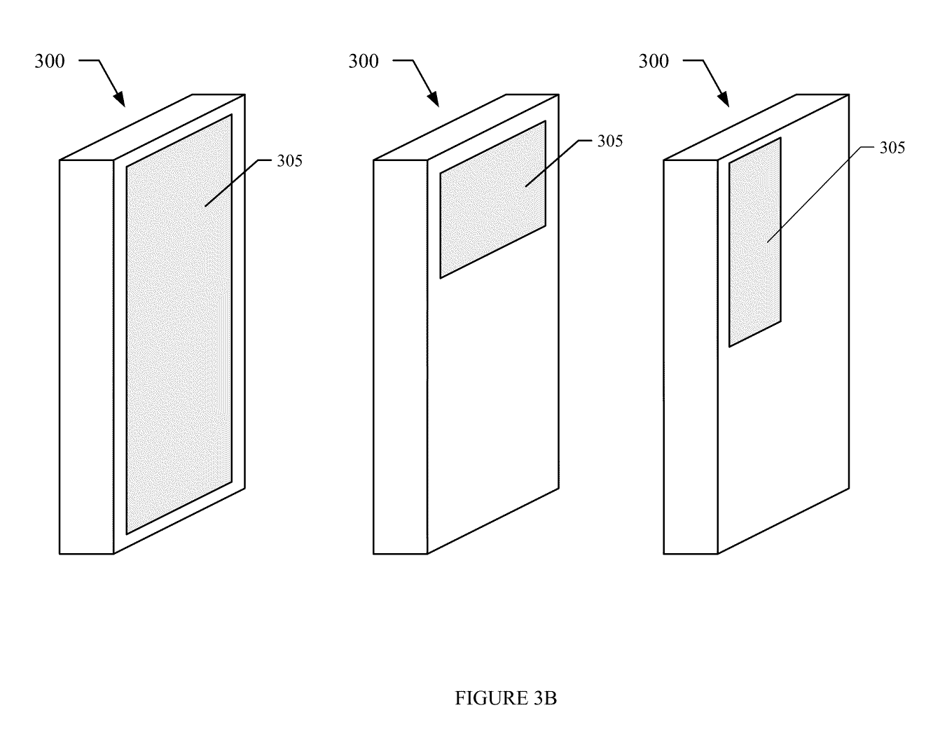

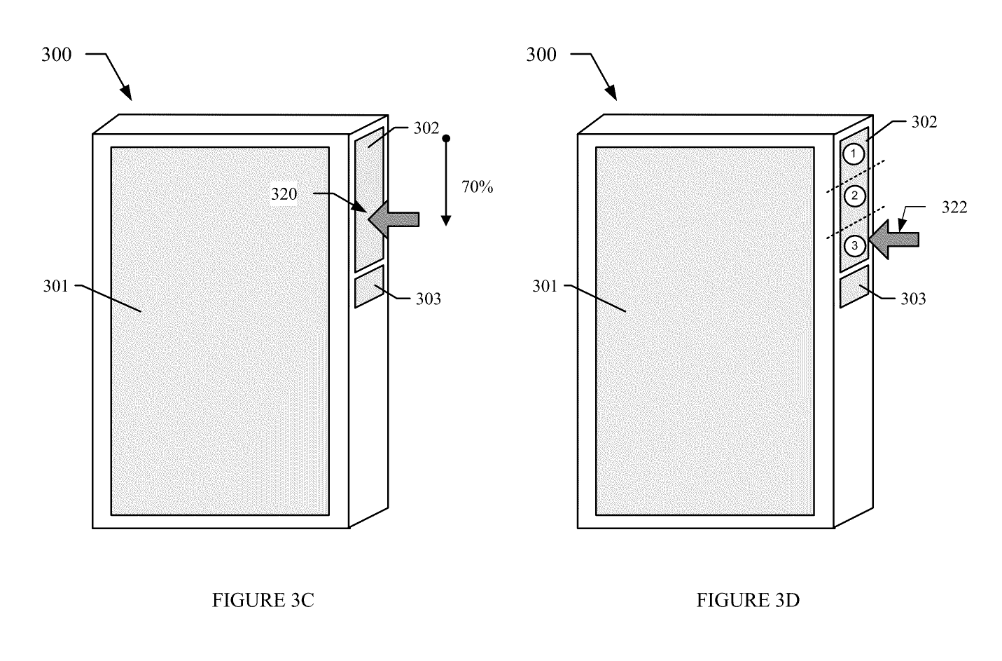

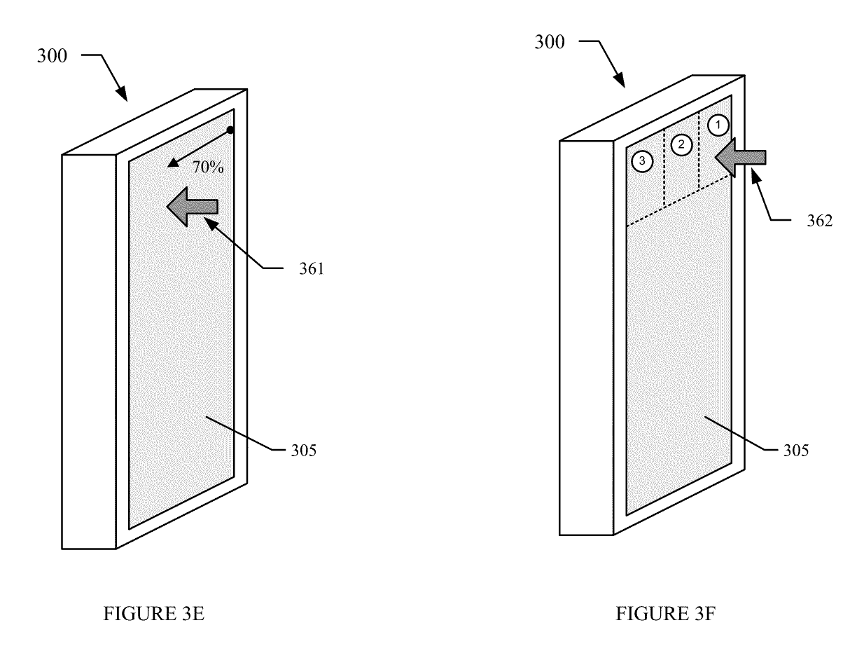

Particular embodiments herein relate to a computing device (such as a mobile phone, netbook, smartphone, tablet, or other portable device) with a touch screen and one or more side-mounted touchpads and methods of allowing users to use the one or more side-mounted touchpads as virtual soft keys. Particular embodiments can improve user experience associated with mobile devices as the virtual soft keys can offload user interaction to the side-mounted touchpad(s), and can be more flexible than traditional soft keys with a fixed number of hardware buttons. FIG. 3 illustrates a front view and a side view of an example mobile device with a front-mounted touch screen and a side-mounted touchpad. In particular embodiments, mobile device 300 may comprise a housing with multi-touch touch screen 301 disposed on a front face of the housing The mobile device 300 may also include a side-mounted multi-touch touchpad 302 and a side-mounted single-touch touchpad 303, both disposed on a lateral face or edge of the device 300. In particular embodiments, mobile device 300 may include hardware and/or software that supports or implements a variety of functions. For example, mobile device 400 may support telephony functions, chat and/or email functions. Mobile device 300 may also support network data communications and include a web browser for accessing and displaying web pages. Mobile device 300 may also support or incorporate a Wi-Fi base station functions, a digital media player functions, and/or a gaming device functions. In one embodiment, the side-mounted touchpad 303 may be replaced by a clickable button or keypad device. In another embodiment, the side-mounted touchpad 303 may be a multi-touch touchpad. In some implementations, the touchpad 302 may be a single- or multi-touch device. In some embodiments, side-mounted touchpad 302 may comprise a slightly concave multi-touch surface, as illustrated in FIG. 3A. The touch screen 301 and side-mounted touchpad 303 may be single-touch, dual-touch or multi-touch devices. In addition, implementations of the invention can operate without a touch screen device, relying instead on a regular display device and a pointer device, such as a trackball or trackpad. In other embodiments, mobile device 300 may include a back-mounted touch surface 305 on a back side of mobile device 300. The back-mounted touch surface 305 may cover substantially all or a portion of a back side of mobile device 300, as illustrated in FIG. 3B. The back-mounted touch surface 305 may comprise a multi-touch touchpad or a multi-touch touch screen.

Mobile device 300 may recognize touch inputs, and determine one or more corresponding touch events or gestures. One or more applications hosted on mobile device 300 may be configured to register a handler function that responds to the one or more touch events. As FIG. 3 illustrates, mobile device 300 has a housing with a side-mounted touchpad 302 disposed on a lateral side of the housing. In particular embodiments, mobile device 300 may recognize one or more user touch inputs performed on touch screen 301, touchpad 302, touchpad 303, and/or back-mounted multi-touch surface 305, and determine one or more corresponding touch events. In particular embodiments, mobile device 300 may detect a tap event associated with touchpad 302 based on a corresponding tap touch gesture of a user, as illustrated in FIG. 3C. In the example of FIG. 3C, a user taps or strikes lightly on touchpad 302 (as indicated by arrow 320), and a gesture recognition library of mobile device 300 can interpret the user's touch input and identify the touch input corresponding to a tap event. In particular embodiments, mobile device 300 may determine a tap location of a tap event. For example, in FIG. 3C, mobile device 300 can determine a relative tap location of a tap event (as illustrated by the arrow 320) as 70% from the top of touchpad 302. For example, if touchpad 302 is 5 cm in length and a user taps on touchpad 302 at a location 3.5 cm from the top of touchpad 302, one or more programs (e.g., a device driver for touchpad 302 and one or more programs from a touch event library as illustrated in FIG. 2) can determine an absolute location (3.5 cm from the top) of the user's touch input, and translate the user's touch input to a tap event with relative location of 70% (i.e., 3.5 divided by 5) from the top of touchpad 302. In one implementation, the touchpad 302 can, in response to a tap event, return the coordinates of the tap event, which a device driver can convert into a relative location or zone. In some embodiments, mobile device 300 may identify a tap location of a tap event based on a plurality of zones dividing touchpad 302, as illustrated in FIG. 3D. In the example of FIG. 3D, touchpad 302 is divided into 3 zones (zone 1 to zone 3), and a gesture recognition library of mobile device 300 can interpret a tap location of zone 3 for a tap event illustrated by arrow 322. In other words, a tap event having a position anywhere within a given region or zone is classified and processed similarly.

In other embodiments, mobile device 300 may identify touch events associated with back-mounted touch surface 305, as illustrated in FIGS. 3E and 3F. In the example of FIG. 3E, a user taps or strikes lightly on back-mounted touch surface 305 (as indicated by arrow 361), and a gesture recognition library of mobile device 300 can interpret the user's touch input and identify the touch input corresponding to a tap event associated with back-mounted touch surface 305. Mobile device 300 may determine a tap location of a tap event associated with back-mounted touch surface 305. For example, in FIG. 3E, mobile device 300 can determine a relative tap location of a tap event (as illustrated by the arrow 361) as 70% from the right edge of back-mounted touch surface 305. For example, if back-mounted touch surface 305 is 10 cm in width and a user taps on back-mounted touch surface 305 at a location 7 cm from the right edge of back-mounted touch surface 305, one or more programs (e.g., a device driver for back-mounted touch surface 305 and one or more programs from a touch event library as illustrated in FIG. 2) can determine an absolute location (7 cm from the right edge) of the user's touch input, and translate the user's touch input to a tap event associated with back-mounted touch surface 305, with relative location of 70% from the right edge of back-mounted touch surface 305. In one embodiment, back-mounted touch surface 305, in response to a tap event, return the coordinates of the tap event, which a device driver can convert into a relative location or zone. In some embodiments, mobile device 300 may identify a tap location of a tap event based on a plurality of zones dividing back-mounted touch surface 305, as illustrated in FIG. 3F. In the example of FIG. 3F, back-mounted touch surface 305 is divided into 3 zones (zone 1 to zone 3), and a gesture recognition library of mobile device 300 can interpret a tap location of zone 3 for a tap event illustrated by arrow 362. In other words, a tap event having a position anywhere within a given region or zones of back-mounted touch surface 305 is classified and processed similarly.

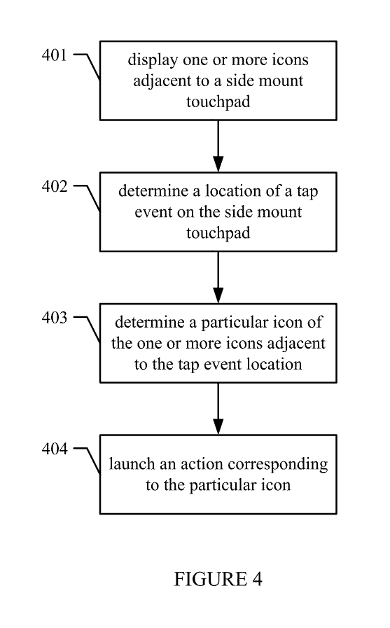

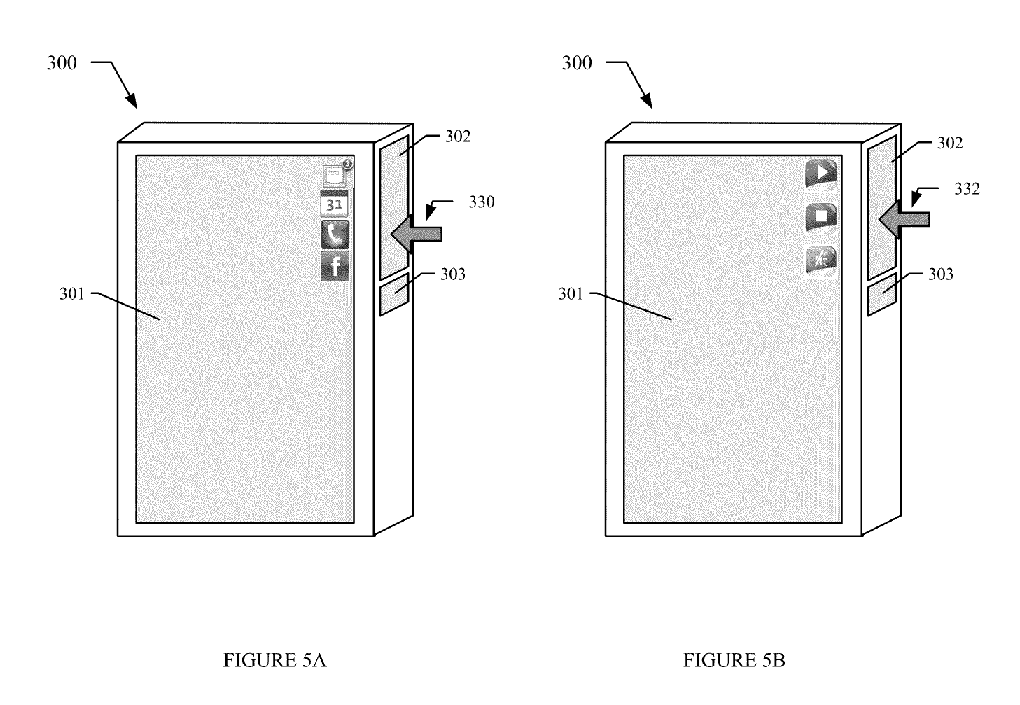

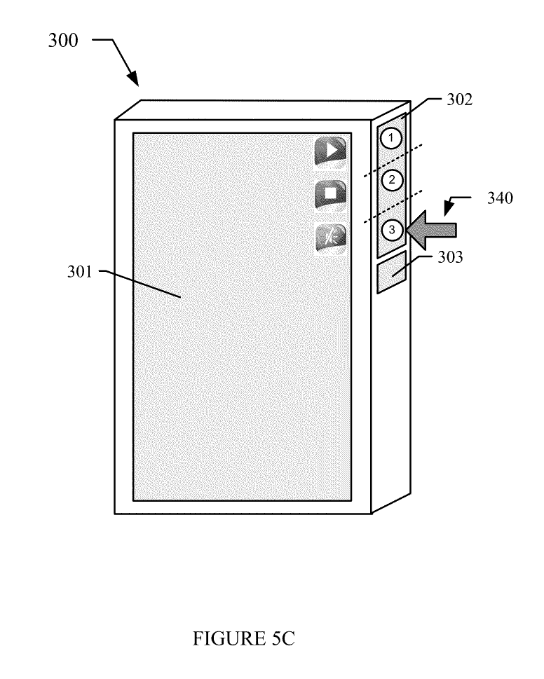

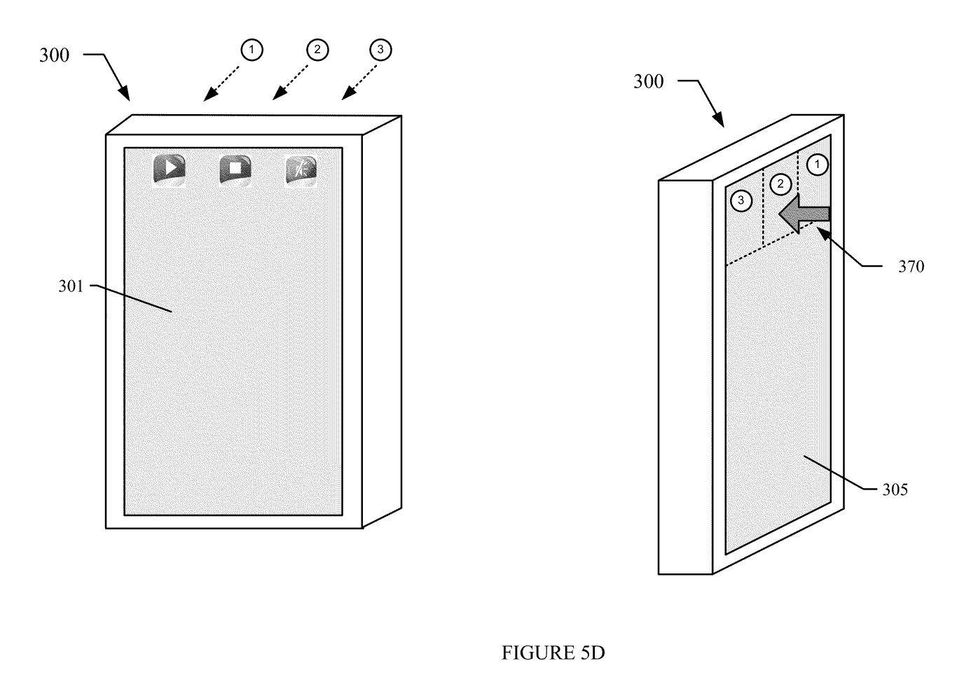

In contrast to using hardware buttons as soft keys, FIG. 4 illustrates an example method of implementing virtual soft keys by using a side-mounted touchpad. Specifically, the example method of FIG. 4 may implement a variable number of soft keys for an application by a side-mounted touchpad. In particular embodiments, an application hosted by a computing device may display one or more icons adjacent to a side mounted touchpad (401). FIGS. 5A-5B illustrate examples of displaying one or more icons adjacent to a side-mounted touchpad. In the example of FIG. 5A, an application running on mobile device 300 (or an operating system of mobile device 300) can display in touch screen 301 four icons adjacent to side-mounted touchpad 302. For example, the icons can, when selected, invoke four different client applications available on mobile device 300 (e.g., Inbox, Calendar, Phone, and Facebook client applications). In the example of FIG. 5B, an application running on mobile device 300 may display in touch screen 301 three icons adjacent to side-mounted touchpad 302. For example, the icons can, when selected, invoke three different functions of the application (e.g., icons for Play, Pause, and Mute functions for a media player client application).

In particular embodiments, the application may display the one or more icons as overlays to the application's user interface. In other embodiments, the application may display the one or more icons associated with a first application as overlaying a user interface of another application. For example, a user may edit a document with a word processor application on the computing device and play an MP3 song using a media player application at the same time, the media player application can display icons (e.g., for functions of the media player application such as Play, Pause, or Mute) adjacent to the side-mounted touchpad, overlaying the user interface of the word processor application. In one embodiment, the application may display the one or more icons only when an object (e.g., a user's finger) is in the proximity of the side-mounted touchpad. In another embodiment, a first tap, swipe or other gesture of the touchpad 302 may cause the icons to appear on the display adjacent to the touchpad. In another embodiment, the icons are displayed after a user invokes a separate command or control, such as pressing button 303, which may cause an operating system shell or a music player (for example) to display the icons.

By registering a handler function for touch events, the handler function can, responsive to a touch event, cause the application to initiate an action corresponding to an icon adjacent to the touch event. In particular embodiments, when a touch event occurs, the handler function may determine if the touch event is a tap event associated with a side-mounted touchpad. In particular embodiments, if the touch event is a tap event associated with a side-mounted touchpad, the handler function may determine a location of the tap event on the side-mounted touchpad (402). In particular embodiments, the handler function may cause the application to determine a particular icon of the one or more icons adjacent to the tap event location (403). For example, the application can determine the third icon from the top (Phone icon) is adjacent to the tap event (as indicated by arrow 330) in FIG. 5A. For example, the application can determine the second icon from the top (Pause icon) is adjacent to the tap event (as indicated by arrow 332) in FIG. 5B. In some embodiments, the application may determine the tap event's location by a particular zone the tap events occurs in, and determine a particular icon of the one or more icons adjacent to the tap event by the particular zone, as illustrated in FIG. 5C. In the example of FIG. 5C, the tap event occurs in zone 3 (as indicated by arrow 340), and the application can determine an icon adjacent to zone 3 (Mute icon) is the icon adjacent to the tap event.

In particular embodiments, the application may launch an action corresponding to the particular icon (404). With the example method of FIG. 4, a user may select an icon by tapping on a side-mounted touchpad at a location adjacent to the icon (i.e., by tapping on a virtual soft key). Using FIG. 5B as an illustration, a user plays an MP3 song using a media player application on mobile device 300, while the media player application can display icons adjacent to side-mounted touchpad 302. The user can tap on side-mounted touchpad 302 at a location adjacent to Pause icon (as indicated by arrow 332), causing the media player application to pause playing the MP3 song, by the example method of FIG. 4. Particular embodiments may also enable interactions with virtual soft keys by using the back-mounted touch surface described earlier. Using FIG. 5D as an illustration, a user plays an MP3 song using a media player application on mobile device 300, while the media player application can display icons near the top of multi-touch touch screen 301. The user can tap on back-mounted touch surface 305 within a zone (e.g. zone 2) corresponding to Pause icon (as indicated by the arrow 370), causing the media player application to pause playing the MP3 song.

Additionally, a user may configure one or more settings of virtual soft keys implemented by the example method of FIG. 4. For example, a user of a mobile device can configure what icons (or what functions) are displayed in a display adjacent to a side-mounted touchpad when an application is running For example, a user can configure how icons are displayed, e.g., whether the icons are always displayed on top of the display, or only displayed when a user's figure is in the proximity of the side-mounted touchpad. In such an implementation, the application may store (and access) the one or more settings in a local storage of the mobile device (e.g., in a microSD card of a mobile phone). Alternatively, the application may store the one or more settings in a remote data store (e.g., the settings can be shared among several computing devices), and periodically (or ad hoc) synchronize between the local copy and the remote copy. An application may also create its own virtual soft key icons and associated behaviors (e.g., the location of an icon, responses to touch events) by using an application programming interface (API) communicating with an operating system and/or software programs (e.g., device drivers for touch screen and/or touchpads, gesture recognition library, etc.) of mobile device 300.

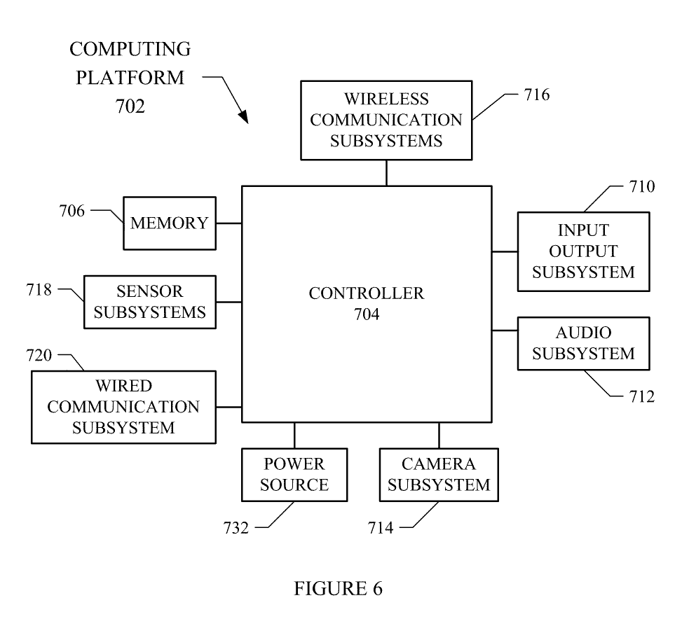

The application and functionality described above can be implemented as a series of instructions stored on a computer-readable storage medium that, when executed, cause a programmable processor to implement the operations described above. While the mobile device 300 may be implemented in a variety of different hardware and computing systems, FIG. 6 shows a schematic representation of the main components of an example computing platform of a client or mobile device, according to various particular embodiments. In particular embodiments, computing platform 702 may comprise controller 704, memory 706, and input output subsystem 710. In particular embodiments, controller 704 which may comprise one or more processors and/or one or more microcontrollers configured to execute instructions and to carry out operations associated with a computing platform. In various embodiments, controller 704 may be implemented as a single-chip, multiple chips and/or other electrical components including one or more integrated circuits and printed circuit boards. Controller 704 may optionally contain a cache memory unit for temporary local storage of instructions, data, or computer addresses. By way of example, using instructions retrieved from memory, controller 704 may control the reception and manipulation of input and output data between components of computing platform 702. By way of example, controller 704 may include one or more processors or one or more controllers dedicated for certain processing tasks of computing platform 702, for example, for 2D/3D graphics processing, image processing, or video processing.

Controller 704 together with a suitable operating system may operate to execute instructions in the form of computer code and produce and use data. By way of example and not by way of limitation, the operating system may be Windows-based, Mac-based, or Unix or Linux-based, Android-based, or Symbian-based, among other suitable operating systems. The operating system, other computer code and/or data may be physically stored within memory 706 that is operatively coupled to controller 704.

Memory 706 may encompass one or more storage media and generally provide a place to store computer code (e.g., software and/or firmware) and data that are used by computing platform 702. By way of example, memory 706 may include various tangible computer-readable storage media including Read-Only Memory (ROM) and/or Random-Access Memory (RAM). As is well known in the art, ROM acts to transfer data and instructions uni-directionally to controller 704, and RAM is used typically to transfer data and instructions in a bi-directional manner. Memory 706 may also include one or more fixed storage devices in the form of, by way of example, hard disk drives (HDDs), solid-state drives (SSDs), flash-memory cards (e.g., Secured Digital or SD cards, embedded MultiMediaCard or eMMD cards), among other suitable forms of memory coupled bi-directionally to controller 704. Information may also reside on one or more removable storage media loaded into or installed in computing platform 702 when needed. By way of example, any of a number of suitable memory cards (e.g., SD cards) may be loaded into computing platform 702 on a temporary or permanent basis.

Input output subsystem 710 may comprise one or more input and output devices operably connected to controller 704. For example, input-output subsystem may include keyboard, mouse, one or more buttons, thumb wheel, and/or display (e.g., liquid crystal display (LCD), light emitting diode (LED), Interferometric modulator display (IMOD), or any other suitable display technology). Generally, input devices are configured to transfer data, commands and responses from the outside world into computing platform 702. The display is generally configured to display a graphical user interface (GUI) that provides an easy to use visual interface between a user of the computing platform 702 and the operating system or application(s) running on the mobile device. Generally, the GUI presents programs, files and operational options with graphical images. During operation, the user may select and activate various graphical images displayed on the display in order to initiate functions and tasks associated therewith. Input output subsystem 710 may also include touch based devices such as touchpad and touch screen. A touchpad is an input device including a surface that detects touch-based inputs of users. Similarly, a touch screen is a display that detects the presence and location of user touch inputs. Input output system 710 may also include dual touch or multi-touch displays or touchpads that can identify the presence, location and movement of more than one touch inputs, such as two or three finger touches.

In particular embodiments, computing platform 702 may additionally comprise audio subsystem 712, camera subsystem 712, wireless communication subsystem 716, sensor subsystems 718, and/or wired communication subsystem 720, operably connected to controller 704 to facilitate various functions of computing platform 702. For example, Audio subsystem 712, including a speaker, a microphone, and a codec module configured to process audio signals, can be utilized to facilitate voice-enabled functions, such as voice recognition, voice replication, digital recording, and telephony functions. For example, camera subsystem 712, including an optical sensor (e.g., a charged coupled device (CCD), or a complementary metal-oxide semiconductor (CMOS) image sensor), can be utilized to facilitate camera functions, such as recording photographs and video clips. For example, wired communication subsystem 720 can include a Universal Serial Bus (USB) port for file transferring, or a Ethernet port for connection to a local area network (LAN). Additionally, computing platform 702 may be powered by power source 732.

Wireless communication subsystem 716 can be designed to operate over one or more wireless networks, for example, a wireless PAN (WPAN) (such as, for example, a BLUETOOTH WPAN, an infrared PAN), a WI-FI network (such as, for example, an 802.11a/b/g/n WI-FI network, an 802.11s mesh network), a WI-MAX network, a cellular telephone network (such as, for example, a Global System for Mobile Communications (GSM) network, an Enhanced Data Rates for GSM Evolution (EDGE) network, a Universal Mobile Telecommunications System (UMTS) network, and/or a Long Term Evolution (LTE) network). Additionally, wireless communication subsystem 716 may include hosting protocols such that computing platform 702 may be configured as a base station for other wireless devices.

Sensor subsystem 718 may include one or more sensor devices to provide additional input and facilitate multiple functionalities of computing platform 702. For example, sensor subsystems 718 may include GPS sensor for location positioning, altimeter for altitude positioning, motion sensor for determining orientation of a mobile device, light sensor for photographing function with camera subsystem 714, temperature sensor for measuring ambient temperature, and/or biometric sensor for security application (e.g., fingerprint reader). Other input/output devices may include an accelerometer that can be used to detect the orientation of the device.

In particular embodiments, various components of computing platform 702 may be operably connected together by one or more buses (including hardware and/or software). As an example and not by way of limitation, the one or more buses may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, a Universal Asynchronous Receiver/Transmitter (UART) interface, a Inter-Integrated Circuit (I²C) bus, a Serial Peripheral Interface (SPI) bus, a Secure Digital (SD) memory interface, a MultiMediaCard (MMC) memory interface, a Memory Stick (MS) memory interface, a Secure Digital Input Output (SDIO) interface, a Multi-channel Buffered Serial Port (McBSP) bus, a Universal Serial Bus (USB) bus, a General Purpose Memory Controller (GPMC) bus, a SDRAM Controller (SDRC) bus, a General Purpose Input/Output (GPIO) bus, a Separate Video (S-Video) bus, a Display Serial Interface (DSI) bus, an Advanced Microcontroller Bus Architecture (AMBA) bus, or another suitable bus or a combination of two or more of these.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a MultiMediaCard (MMC) card, an embedded MMC (eMMC) card, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

This disclosure contemplates one or more computer-readable storage media implementing any suitable storage. In particular embodiments, a computer-readable storage medium implements one or more portions of controller 704 (such as, for example, one or more internal registers or caches), one or more portions of memory 705, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, JavaScript, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method, comprising:
displaying one or more icons in a display mounted adjacent to a side-mounted touchpad of a computing device;
in response to a tap event on the side-mounted touchpad, determining a location of the touchpad corresponding to the tap event;
determining a particular icon of the one or more icons that is adjacent to the location of the tap event; and
initiating an action corresponding to the particular icon.

2. The method of claim 1 wherein the displaying one or more icons in a display mounted adjacent to a side-mounted touchpad of a computing device comprises:
displaying the one or more icons in the display mounted adjacent to the side-mounted touchpad of the computing device in response to a user input.

3. The method of claim 2 wherein the user input is a touch input.

4. The method of claim 1 wherein the action comprises launching an application hosted by the computing device.

5. The method of claim 1 wherein the action comprising initiating a function of an application hosted by the computing device.

6. An apparatus, comprising:
a device housing;
a memory;
one or more processors;
a display;
a side-mounted touchpad disposed on a lateral side of the device housing;
a program comprising computer-readable instructions operative, when executed, to cause the one or more processors to:
display one or more icons in the display adjacent to the side-mounted touchpad;
in response to a tap event on the touchpad, determine a location of the touchpad corresponding to the tap event;
determine a particular icon of the one or more icons that is adjacent to the location of the tap event; and
initiate an action corresponding to the particular icon.

7. The apparatus of claim 6 wherein the display comprises a touch screen.

8. The apparatus of claim 6 wherein the side-mounted touchpad comprises a concave touch surface.

9. The apparatus of claim 6 wherein, to display one or more icons in the display adjacent to the side-mounted touchpad, comprises instructions operative to cause the one or more programs to:
display the one or more icons in the display mounted adjacent to the side-mounted touchpad of the computing device in response to a user input.

10. The apparatus of claim 9 wherein the user input is a touch input.

11. The apparatus of claim 6 wherein the action comprises launching an application hosted by the apparatus.

12. The apparatus of claim 6 wherein the action comprises initiating a function of an application hosted by the apparatus.

13. One or more computer readable tangible storage media embodying software operable when executed by a computing device to:
display one or more icons in a display mounted adjacent to a side-mounted touchpad of the computing device;
in response to a tap event on the side-mounted touchpad, determine a location of the touchpad corresponding to the tap event;
determine a particular icon of the one or more icons that is adjacent to the location of the tap event; and
initiate an action corresponding to the particular icon.

14. The media of claim 13, wherein to display one or more icons in a display mounted adjacent to a side-mounted touchpad of the computing device, further comprises software operable when executed by the computing device to:
display the one or more icons in the display mounted adjacent to the side-mounted touchpad of the computing device in response to a user input.

15. The media of claim 14, wherein the user input is a touch input.

16. The media of claim 13, wherein the action comprises launching an application hosted by the computing device.

17. The media of claim 13, wherein the action comprises initiating a function of an application hosted by the computing device.
